(19) United States
(12) Patent Application Publication
(10) Pub. No.: US 2013/0273283 A1
(43) Pub. Date: Oct. 17, 2013

(54) Ultraviolet Radiation Stabilized Polyarylene Sulfide Composition

(71) Applicant: Ticona LLC, Florence, KY (US)

(72) Inventors: Ke Feng, Cincinnati, OH (US); Rong Luo, Florence, KY (US); Xinyu Zhao, Cincinnati, OH (US)

(73) Assignee: TICONA LLC, Florence, KY (US)

(21) Appl. No.: 13/799,204

(22) Filed: Mar. 13, 2013

Related U.S. Application Data
(60) Provisional application No. 61/623,651, filed on Apr. 13, 2012.

(51) Int. Cl. C09K 21/14; D01G 15/00

(52) U.S. Cl. CPC C09K 21/14; D01G 15/00
USPC 428/36.9; 252/601; 442/335; 428/220; 428/359; 428/401; 19/98; 264/41; 264/319; 264/328.1; 264/523; 264/345; 442/192

(57) ABSTRACT

Disclosed is a UV stabilized polyarylene sulfide composition, methods of forming the composition, and UV stabilized products that can be formed of the composition. The UV stabilized polyarylene sulfide composition can include a reactively functionalized polyarylene sulfide polymer in conjunction with a UV stabilizer. The reactivity of the polyarylene sulfide polymer is formed during melt processing via reaction of a reactively functionalized disulfide compound with a starting polyarylene sulfide. The reactivity of the polyarylene sulfide can encourage interaction between the polyarylene sulfide polymer and the UV stabilizer, which can improve dispersion of the UV stabilizer throughout the composition and improve miscibility between the polyarylene sulfide polymer and the UV stabilizer. Products can incorporate high concentrations of UV stabilizer and/or can be formed to very small cross sectional dimensions without phase separation between the UV stabilizer and the polyarylene sulfide.

### CROSS REFERENCE TO RELATED APPLICATION

The present application claims filing benefit of U.S. Provisional Patent Application Ser. No. 61/623,651 having a filing date of Apr. 13, 2012, which is incorporated herein by reference in its entirety.

### BACKGROUND OF THE INVENTION

Polyarylene sulfides are high-performance polymers that are able to withstand high thermal, chemical, and mechanical stresses and possess inherent flame retardancy. Moreover, polyarylene sulfides can be safely incinerated following use, and as such are considered to be environmentally friendly high performance materials. Products formed of polyarylene sulfides have proven advantageous in a variety of applications due to such beneficial characteristics. For instance, polyarylene sulfide fibers have been suggested for use in forming textiles for use in apparel, filter bags, filter screens, conveyor belts, insulation materials, etc. Polyarylene sulfide materials have also found beneficial use in forming components for transportation applications, such as injection molded automotive components.

Unfortunately, polyarylene sulfides are subject to degradation by ultraviolet (UV) radiation. A variety of UV stabilizers have been developed for use with polymers, but such additives are generally not compatible with the polyarylene sulfide polymer, leading to phase separation during processing. While phase separation is always a problem, it can be particularly problematic when forming components that have a small cross sectional dimension, such as small diameter fibers or small cross sectional tapes, films or molded parts. In an attempt to prevent phase separation between polyarylene sulfide polymers and UV stabilizers, the acceptable amount of UV stabilizer that is added to the composition is generally severely limited. However, even at small additive amounts, phase separation during formation of small cross sectional dimension components is still a serious problem. Moreover, low level of UV stabilizer add-in also limits the effectiveness of the additive, with the UV stabilized products still exhibiting a high level of susceptibility to UV radiation.

What are needed in the art are polyarylene sulfide compositions that can be utilized to form UV stabilized products and components of very small cross sectional dimensions. In addition, what are needed in the art are polyarylene sulfide compositions that can incorporate high levels of UV stabilizers and products formed therefrom that can exhibit high resistance to UV induced degradation.

### SUMMARY OF THE INVENTION

According to one embodiment, disclosed is a polyarylene sulfide composition that includes a reactively functionalized polyarylene sulfide and a UV stabilizer. The polyarylene sulfide composition can have a color shift ΔE following a period of UV aging that is less than about 90% of that of a second polyarylene sulfide composition. The second polyarylene sulfide composition varying from the polyarylene sulfide composition only in that the polyarylene sulfide of the second composition does not include reactive functionality as does the reactively functionalized polyarylene sulfide.

According to another embodiment, disclosed is a product having a small cross sectional dimension. The product can be formed of a polyarylene sulfide composition that includes a reactively functionalized polyarylene sulfide and a UV stabilizer. For instance, the product can define a cross section of less than about 10 millimeters. By way of example, the product can be a fiber, a filament, a tape, a film, an injection molded or blow molded product such as a pipe or a hose, or the like.

Also disclosed is a method for forming a polyarylene sulfide composition. For instance, a method can include melt processing a starting polyarylene sulfide, a reactively functionalized disulfide compound, and a UV stabilizer. The polyarylene sulfide and the reactively functionalized disulfide compound can react with one another during processing to form a reactively functionalized polyarylene sulfide. The melt viscosity of the polyarylene sulfide composition formed according to the process can be less than that of a similar composition that has not been formed in conjunction with a reactively functionalized disulfide compound.

### BRIEF DESCRIPTION OF THE FIGURES

The present disclosure may be better understood with reference to the following figures:

FIG. 1 illustrates a formation method as may be used in forming melt blown staple fibers or filaments of the polyarylene sulfide composition.

FIG. 2 illustrates a dry-laid carding method as may be utilized in forming a web including polyarylene sulfide fibers as described herein.

FIG. 3 illustrates a fibrous mat as may incorporate polyarylene sulfide fibers as described herein.

FIG. 4 illustrates a formation method as may be used in forming drawn fibers of the polyarylene sulfide composition.

FIG. 5 illustrates several vehicle dashboard components as may incorporate the polyarylene sulfide composition as described herein.

FIG. 6 illustrates an airplane aileron including a leading edge component as may incorporate the polyarylene sulfide composition as described herein.

FIG. 7 is a single layer tubular member as may be formed from the polyarylene sulfide composition.

FIG. 8 is a multi-layer tubular member, one or more layers of which may be formed from the polyarylene sulfide composition.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to a UV stabilized polyarylene sulfide composition, methods of forming the composition, and UV stabilized components and products that can advantageously incorporate the composition. More specifically, the UV stabilized polyarylene sulfide composition can include a reactively functionalized polyarylene sulfide polymer in conjunction with a UV stabilizer. The reactivity of the polyarylene sulfide polymer can encourage interaction between the polyarylene sulfide polymer and the UV stabilizer, which can improve dispersion of the UV stabilizer throughout the composition and improve miscibility between the polyarylene sulfide polymer and the UV stabilizer.

Improved dispersion of the UV stabilizer throughout the polyarylene sulfide composition can inhibit phase separation between the polyarylene sulfide polymer and the UV stabilizer during processing of the composition. The prevention of phase separation can allow for the formation of UV stabilized products that previously either could not be formed at all or were very difficult to form and had high failure rates. For example, UV stabilized products that have a small cross sectional dimension of less than about 10 millimeters, less than about 2 millimeters, less than about 1 millimeter, or less than about 100 micrometers (e.g., less than about 50 micrometers, less than about 20 micrometers, or less than about 10 micrometers) can be formed by use or the polyarylene sulfide composition. Examples of small cross sectional products can include filaments or staple fibers as well as small cross sectional extruded or molded material that can be formed from the UV stabilized polyarylene sulfide composition due to the prevention of phase separation during processing. For example, UV stabilized fibers having a linear mass density of less than about 6 grams per 10,000 meters (denier of less than about 6.7 dpf), less than about 5 grams per 10,000 meters (less than about 5.6 dpf), less than about 4 grams per 10,000 meters (less than about 4.4 dpf), or less than about 3 grams per 10,000 meters (less than about 3.3 dpf) can be formed from the UV stabilized polyarylene sulfide composition. Drawn fibers can have even lower linear mass density, for instance less than about 2 grams per 10,000 meters (less than about 2.2 dpf), or less than about 1.5 grams per 10,000 meters (less than about 1.6 dpf). For instance, drawn staple fibers can have a cross sectional diameter of less than about 100 micrometers, for instance between about 20 and about 50 micrometers, and melt blow fibers can be formed to even smaller diameters, for instance less than about 10 micrometers, or between about 1 and about 5 micrometers.

In addition to inhibiting phase separation, utilization of a reactively functionalized polyarylene sulfide polymer in conjunction with a UV stabilizer can promote the incorporation of high levels of the UV stabilizer into the polyarylene sulfide composition. For instance, the polyarylene sulfide composition can include a UV stabilizer in an amount of greater than about 0.5 wt. %, greater than about 1 wt. %, greater than about 2 wt. %, greater than about 5 wt. %, or greater than about 10 wt. % by weight of the polyarylene sulfide composition. By way of example, the polyarylene sulfide composition can include between about 0.5 wt. % and about 15 wt. %, between about 1 wt. % and about 8 wt. %, or between about 1.5 wt. % and about 7 wt. % of a UV stabilizer. Higher levels of UV stabilizer in the composition can increase the resistance of products formed of the polyarylene sulfide composition to degradation due to UV radiation.

UV degradation resistance provided to products that incorporate the polyarylene sulfide composition can not only provide longer life to the product due to maintenance of strength characteristics, but can also provide improved appearance to the product over the life of the product. Discoloration of a product as a result of UV degradation can occur due to breakdown of the polyarylene sulfide polymer itself as well as due to degradation of colorants that are included in the composition and/or coated on the product formed of the composition. Beneficially, the UV stabilizers of the polyarylene sulfide composition can prevent degradation of not only the polyarylene sulfide polymer of the composition, but can also prevent degradation of such colorants, and can thereby prevent discoloration of the product. Moreover, it is believed that the presence of the reactively functionalized polyarylene sulfide polymer in the composition can also promote improved dispersion and miscibility of colorants that are incorporated into the UV stabilized polyarylene sulfide composition. This improved dispersion and miscibility can allow for a relatively high concentration of a colorant to be included in the polyarylene sulfide composition, which can also help to improve the appearance of the product over the product's life. When considering colorants that are applied to a surface of a formed product or component, it is believed that the reactively functionalized polyarylene sulfide of the composition can promote improved adhesion between the formed surface and the applied colorant, which can likewise improve the appearance of the product over the product's life.

Through utilization of the reactively functionalized polyarylene sulfide in conjunction with the UV stabilizer, products formed with the polyarylene sulfide composition can exhibit excellent resistance to degradation due to UV radiation. For example, the polyarylene sulfide composition (and products formed therefrom) can exhibit less variation in color following a period of UV aging as compared to a similar composition that includes a typical, non-functionalized polyarylene sulfide. For instance, a product formed of the polyarylene sulfide composition that includes a reactively functionalized polyarylene sulfide in conjunction with a UV stabilizer can exhibit a ΔE following a period of UV aging that is less than about 25, less than about 20, or less than about 18. In one embodiment, the polyarylene sulfide composition can exhibit a ΔE that is less than about 90%, less than about 80%, or less than about 70% of the ΔE of a second product formed of a second composition that varies from the polyarylene sulfide composition only in that the second composition includes a non-functionalized polyarylene sulfide rather than the reactively functionalized polyarylene sulfide. UV aging can be carried out, for example, over a period of about 16 hours of UV exposure at about 1 W/m² at 420 nm, e.g., for a total UV exposure of about 50 kJ/m². Of course, other UV exposure conditions can alternatively be applied. For instance, an accelerated UV aging process as is known in the art can alternatively be utilized.

The variation in effect of UV aging can be quantified by measuring the absorbance with an optical reader in accordance with a standard test methodology known as “CIELAB”, which is described in Pocket Guide to Digital Printing by F. Cost, Delmar Publishers, Albany, N.Y. ISBN 0-8273-7592-1 at pages 144 and 145 and “Photoelectric color difference meter”, Journal of Optical Society of America, volume 48, page numbers 985-995, S. Hunter, (1958), both of which are incorporated herein by reference in their entirety. More specifically, the CIELAB test method defines three “Hunter” scale values, L*, a*, and b*, which correspond to three characteristics of a perceived color based on the opponent theory of color perception and are defined as follows:

L*=Lightness (or luminosity), ranging from 0 to 100, where 0=dark and 100=light;

a*=Red/green axis, ranging from −100 to 100; positive values are reddish and negative values are greenish; and

b*=Yellow/blue axis, ranging from −100 to 100; positive values are yellowish and negative values are bluish.

Color measurement can be performed using a DataColor 650 Spectrophotometer utilizing an integrating sphere with measurements made using the specular included mode. Color coordinates can likewise be calculated according to ASTM D2244-11 under an illuminant D65/10°, A/10°, or F2/10° observer, using CIELAB units. Because CIELAB color space is somewhat visually uniform, the delta value ΔE may be calculated that represents the total absolute color difference between two colors (e.g., prior to and following UV aging) as perceived by a human using the following equation:

ΔE=[(ΔL*)²+(Δa*)²+(Δb*)²]^{1/2}

wherein, ΔL* is the luminosity value of the color of the specimen following UV aging subtracted from the luminosity value of the color of the specimen prior to UV aging, Δa* is the red/green axis value of the color of the specimen following UV aging subtracted from the red/green axis value of the color of the specimen prior to UV aging; and Δb* is the yellow/blue axis value of the color of the specimen following UV aging subtracted from the yellow/blue axis value of the color of the specimen prior to UV aging. In CIELAB color space, each ΔE unit is approximately equal to a “just noticeable” difference between two colors and is therefore a good measure for an objective device-independent color specification system that may be used for the purpose of expressing differences in color.

The polyarylene sulfide composition can also exhibit excellent processibility and low halogen content. To form the reactively functionalized polyarylene sulfide of the composition, a starting polyarylene sulfide can be melt processed in conjunction with a reactively functionalized disulfide compound. Reaction between the starting polyarylene sulfide and the reactively functional disulfide compound in the melt can lead to addition of the reactive functional groups of the disulfide compound to the starting polyarylene sulfide backbone, thus forming the reactively functionalized polyarylene sulfide. In addition, the reaction between the disulfide compound and the starting polyarylene sulfide can also lead to polymer scission of the starting polyarylene sulfide polymer. Due to this polymer scission, the reactively functionalized polyarylene sulfide can exhibit a lower melt viscosity as compared to the starting polyarylene sulfide. For example, the polyarylene sulfide composition including the reactively functionalized polyarylene sulfide can exhibit a melt viscosity that is less than about 50%, less than about 48%, or less than about 45% of the melt viscosity of a similar polyarylene sulfide composition that includes the starting polyarylene sulfide. A similar polyarylene sulfide composition is one that includes all of the same components in the same amounts save for the addition of the reactively functionalized disulfide compound. Decrease in melt viscosity of the polyarylene sulfide polymer can improve processibility of the composition and can provide associated cost savings when forming a product from the reactively functionalized polyarylene sulfide composition. For example, the polyarylene sulfide composition may have a melt viscosity of less than about 1800 poise, less than about 1500 poise, or less than about 1200 poise as determined in accordance with ISO Test No. 11443 at a shear rate of 1200 s⁻¹ and at a temperature of 310° C. By way of example, the polyarylene sulfide composition may have a melt viscosity of between about 800 and about 1800 poise, or between about 1000 and about 1300 poise as determined in accordance with ISO Test No. 11443 at a shear rate of 1200 s⁻¹ and at a temperature of 310° C.

Moreover, as the starting polyarylene sulfide can be a high molecular weight, high melt viscosity polyarylene sulfide, it can also have a low halogen content (higher molecular weight polyarylene sulfides will include fewer terminal groups and hence have lower halogen content). The polymer scission of the starting polyarylene sulfide can decrease the melt viscosity and provide a polymer with good processibility characteristics while maintaining the low halogen content of the starting polymer. Thus, the polyarylene sulfide composition can likewise have a low halogen content. For instance, the UV stabilized polyarylene sulfide composition can have a halogen content of less than about 1500 ppm, less than about 1000 ppm, less than about 900 ppm, less than about 600 ppm, or less than about 400 ppm. Halogen content can be determined, for example, according to an elemental analysis using Parr Bomb combustion followed by ion chromatography.

The starting polyarylene sulfide may be a polyarylene thioether containing repeat units of the formula (I):

—[(Ar¹)ₙ—X]ₘ—[(Ar²)ᵢ—Y]ⱼ—[(Ar³)ₖ—Z]ₗ—[(Ar⁴)ₒ—W]ₚ— (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, I, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The starting polyarylene sulfide typically includes more than about 30 mol %, more than about 50 mol %, or more than about 70 mol % arylene sulfide (—S—) units. In one embodiment the starting polyarylene sulfide includes at least 85 mol % sulfide linkages attached directly to two aromatic rings. In one embodiment, the starting polyarylene sulfide is a polyphenylene sulfide, defined herein as containing the phenylene sulfide structure —(C₆H₄—S)ₙ—(wherein n is an integer of 1 or more) as a component thereof.

The formation process of the composition can include synthesis of the starting polyarylene sulfide, which may be synthesized prior to forming the reactively functionalized polyarylene sulfide. However, this is not a requirement of the composition formation process, and in other embodiments, a starting polyarylene sulfide can be purchased from known suppliers. For instance Fortron® polyphenylene sulfide available from Ticona of Florence, Ky., USA can be purchased and utilized as the starting polyarylene sulfide.

Synthesis techniques that may be used in forming a starting polyarylene sulfide are generally known in the art. By way of example, a process for producing a polyarylene sulfide can include reacting a material that provides a hydrosulfide ion, e.g., an alkali metal sulfide, with a dihaloaromatic compound in an organic amide solvent.

The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone.

The halogen atom can be fluorine, chlorine, bromine or iodine, and 2 halogen atoms in the same dihalo-aromatic compound may be the same or different from each other. In one embodiment, o-dichlorobenzene, m-dichlorobenzene, p-dichlorobenzene or a mixture of 2 or more compounds thereof is used as the dihalo-aromatic compound.

As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The starting polyarylene sulfide may be a homopolymer or may be a copolymer. By a suitable, selective combination of dihaloaromatic compounds, a polyarylene sulfide copolymer can be formed containing not less than two different units. For instance, in the case where p-dichlorobenzene is used in combination with m-dichlorobenzene or 4,4′-dichlorodiphenylsulfone, a starting polyarylene sulfide copolymer can be formed containing segments having the structure of formula (II):

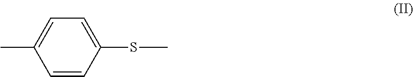

and segments having the structure of formula (III):

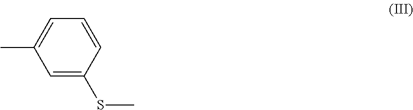

or segments having the structure of formula (IV):

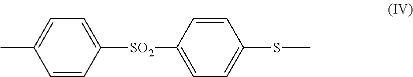

In general, the amount of the dihaloaromatic compound(s) per mole of the effective amount of the charged alkali metal sulfide can generally be from 1.0 to 2.0 moles, from 1.05 to 2.0 moles, or from 1.1 to 1.7 moles. Thus, the polyarylene sulfide can include alkyl halide (generally alkyl chloride) end groups.

A process for producing the starting polyarylene sulfide can include carrying out the polymerization reaction in an organic amide solvent. Exemplary organic amide solvents used in a polymerization reaction can include, without limitation, N-methyl-2-pyrrolidone; N-ethyl-2-pyrrolidone; N,N-dimethylformamide; N,N-dimethylacetamide; N-methylcaprolactam; tetramethylurea; dimethylimidazolidinone; hexamethyl phosphoric acid triamide and mixtures thereof. The amount of the organic amide solvent used in the reaction can be, e.g., from 0.2 to 5 kilograms per mole (kg/mol) of the effective amount of the alkali metal sulfide.

The polymerization can be carried out by a step-wise polymerization process. The first polymerization step can include introducing the dihaloaromatic compound to a reactor, and subjecting the dihaloaromatic compound to a polymerization reaction in the presence of water at a temperature of from about 180° C. to about 235° C., or from about 200° C. to about 230° C., and continuing polymerization until the conversion rate of the dihaloaromatic compound attains to not less than about 50 mol % of the theoretically necessary amount.

In a second polymerization step, water is added to the reaction slurry so that the total amount of water in the polymerization system is increased to about 7 moles, or to about 5 moles, per mole of the effective amount of the charged alkali metal sulfide. Following, the reaction mixture of the polymerization system can be heated to a temperature of from about 250° C. to about 290° C., from about 255° C. to about 280° C., or from about 260° C. to about 270° C. and the polymerization can continue until the melt viscosity of the thus formed starting polymer is raised to the desired final level of the polyarylene sulfide. The duration of the second polymerization step can be, e.g., from about 0.5 to about 20 hours, or from about 1 to about 10 hours.

The starting polyarylene sulfide may be linear, semi-linear, branched or crosslinked. A linear polyarylene sulfide includes as the main constituting unit the repeating unit of —(Ar—S) —. In general, a linear polyarylene sulfide may include about 80 mol % or more of this repeating unit. A linear polyarylene sulfide may include a small amount of a branching unit or a cross-linking unit, but the amount of branching or cross-linking units may be less than about 1 mol % of the total monomer units of the polyarylene sulfide. A linear polyarylene sulfide polymer may be a random copolymer or a block copolymer containing the above-mentioned repeating unit.

A semi-linear polyarylene sulfide may be utilized as the starting polyarylene sulfide that may have a cross-linking structure or a branched structure provided by introducing into the polymer a small amount of one or more monomers having three or more reactive functional groups. For instance between about 1 mol % and about 10 mol % of the polymer may be formed from monomers having three or more reactive functional groups. Methods that may be used in making semi-linear polyarylene sulfide are generally known in the art. By way of example, monomer components used in forming a semi-linear polyarylene sulfide can include an amount of polyhaloaromatic compounds having 2 or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, and the like, and mixtures thereof.

Following polymerization, the starting polyarylene sulfide may be washed with liquid media. For instance, the starting polyarylene sulfide may be washed with water and/or organic solvents that will not decompose the polyarylene sulfide including, without limitation, acetone, N-methyl-2-pyrrolidone, a salt solution, and/or an acidic media such as acetic acid or hydrochloric acid prior to combination with other components while forming the mixture. The starting polyarylene sulfide can be washed in a sequential manner that is generally known to persons skilled in the art. Washing with an acidic solution or a salt solution may reduce the sodium, lithium or calcium metal ion end group concentration from about 2000 ppm to about 100 ppm.

A starting polyarylene sulfide can be subjected to a hot water washing process. The temperature of a hot water wash can be at or above about 100° C., for instance higher than about 120° C., higher than about 150° C., or higher than about 170° C.

The polymerization reaction apparatus for forming the starting polyarylene sulfide is not especially limited, although it is typically desired to employ an apparatus that is commonly used in formation of high viscosity fluids. Examples of such a reaction apparatus may include a stirring tank type polymerization reaction apparatus having a stirring device that has a variously shaped stirring blade, such as an anchor type, a multistage type, a spiral-ribbon type, a screw shaft type and the like, or a modified shape thereof. Further examples of such a reaction apparatus include a mixing apparatus commonly used in kneading, such as a kneader, a roll mill, a Banbury mixer, etc. Following polymerization, the molten starting polyarylene sulfide may be discharged from the reactor, typically through an extrusion orifice fitted with a die of desired configuration, cooled, and collected. Commonly, the starting polyarylene sulfide may be discharged through a perforated die to form strands that are taken up in a water bath, pelletized and dried. The starting polyarylene sulfide may also be in the form of a strand, granule, or powder.

The molecular weight of the starting polyarylene sulfide polymer or copolymer is not particularly limited, though in one embodiment, the starting polyarylene sulfide (which can also encompass a blend of one or more starting polyarylene sulfide polymers and/or copolymers) may have a relative high molecular weight and a low halogen content. For instance a starting polyarylene sulfide may have a number average molecular weight greater than about 25,000 g/mol, or greater than about 30,000 g/mol, and a weight average molecular weight greater than about 60,000 g/mol, or greater than about 65,000 g/mol. A low halogen content starting polyarylene sulfide can generally have a halogen content of less than about 1500 ppm, less than about 1000 ppm, less than about 900 ppm, less than about 600 ppm, or less than about 400 ppm.

The starting polyarylene sulfide can be melt processed with a reactively functionalized disulfide compound to form the reactively functionalized polyarylene sulfide. In one embodiment, the reactively functionalize polyarylene sulfide can be synthesized in conjunction with the formation of the starting polyarylene sulfide, i.e., a starting polyarylene sulfide can be synthesized and the starting polyarylene sulfide can be reactively functionalized by reaction with a disulfide compound in-line with the initial formation of the polymer to form the reactively functionalized polyarylene sulfide. As previously stated, however, this is not a requirement, and the starting polyarylene sulfide can be synthesized separately and prior to formation of the reactively functionalized polyarylene sulfide.

In general, the disulfide compound may have the structure of formula (V):

R¹—S—S—R² (V)

wherein R¹ and R² may be the same or different and are hydrocarbon groups that independently include from 1 to about 20 carbons. For instance, R¹ and R² may be an alkyl, cycloalkyl, aryl, or heterocyclic group. In addition, at least one of R¹ and R² will include reactive functionality at terminal end(s) of the disulfide compound. For example, at least one of R¹ and R² may include a terminal carboxyl group, hydroxyl group, a substituted or non-substituted amino group, a nitro group, or the like. Examples of disulfide compounds including reactive terminal groups as may be combined with a starting polyarylene sulfide may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid, dithioglycolic acid, α,α,′-dithiodilactic acid, β,β′-dithiodilactic acid, 3,3′-dithiodipyridine, 4,4′ dithiomorpholine, 2,2′-dithiobis(benzothiazole), 2,2′-dithiobis(benzimidazole), 2,2′-dithiobis(benzoxazole) and 2-(4′-morpholinodithio)benzothiazole.

The ratio of the amount of the starting polyarylene sulfide to the amount of the disulfide compound utilized can be from about 1000:1 to about 10:1, from about 500:1 to about 20:1, or from about 400:1 to about 30:1. In one embodiment, enough of the reactively functionalized disulfide compound can be added to the starting polyarylene sulfide so as to develop the desired melt viscosity of the reactively functionalized polyarylene sulfide composition. However, too much disulfide compound added to the starting polyarylene sulfide can lead to undesired interaction between the reactively functionalized disulfide compound and other components of the mixture, e.g., the UV stabilizer, during formation of the polyarylene sulfide composition.

The polyarylene sulfide composition may include the reactively functionalized polyarylene sulfide (which also encompasses a blend of polyarylene sulfides) in an amount from about 10 wt. % to about 99.5 wt. % by weight of the composition, for instance from about 20% wt. % to about 90 wt. % by weight of the composition.

The reactively functionalized polyarylene sulfide may be of any suitable molecular weight and melt viscosity, generally depending upon the final application intended for the polyarylene sulfide composition and the processing methodology to be used in forming the composition. For instance, the reactively functionalized polyarylene sulfide may be a low viscosity material, having a melt viscosity of less than about 500 poise, a medium viscosity polyarylene sulfide, having a melt viscosity of between about 500 poise and about 1500 poise, or a high melt viscosity polyarylene sulfide, having a melt viscosity of greater than about 1,500 poise. Melt viscosity may be determined in accordance with ISO Test No. 11443 at a shear rate of 1200 s⁻¹ and at a temperature of 310° C.

The reactively functionalized polyarylene sulfide can be combined with a UV stabilizer to form the polyarylene sulfide composition. In one embodiment, the reactive functionalization of the starting polyarylene sulfide can be carried out in conjunction with the formation of the UV stabilized composition. For instance, a starting polyarylene sulfide polymer can be melt processed with the reactively functionalized disulfide compound and with the UV stabilizer to form the composition. In this embodiment, the reactively functionalized disulfide compound and the UV stabilizer can be added to the starting polyarylene sulfide in a melt processing unit in conjunction with one another or separately, as desired. According to another embodiment, the reactively functionalized polyarylene sulfide can be formed in a separate operation and following this formation the reactively functionalized polyarylene sulfide can be melt processed with the UV stabilizer.

One particularly suitable UV stabilizer that may be employed is a hindered amine UV stabilizer. Suitable hindered amine UV stabilizer compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. The hindered amine may, for example, be an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit. One particularly suitable high molecular weight hindered amine is commercially available from Clariant under the designation Hostavin® N30 (number average molecular weight of 1200). Another suitable high molecular weight hindered amine is commercially available from Adeka Palmarole SAS under the designation ADK STAB® LA-63 and ADK STAB® LA-68. Yet other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-5-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinyl)-siloxane (Uvasil® 299 from Great Lakes Chemical, MW=1100 to 2500); copolymer of α-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth.

In addition to the high molecular hindered amines, low molecular weight hindered amines may also be employed. Such hindered amines are generally monomeric in nature and have a molecular weight of about 1000 or less, in some embodiments from about 155 to about 800, and in some embodiments, from about 300 to about 800. Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert.butyl-4-hydroxybenzyl)butyl-propane dioate; bis-(1,2,2,6,6-pentamethyl-4-piperidinyl) sebacate; 8-acetyl-3-dodecyl-7,7,9,9-tetramethyl-1,3,8-triazaspiro-(4,5)-decane-2,4-dione; butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-2′-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione; (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl) propionylamide; 1,2-bis-(3,3,5,5-tetramethyl-2-oxo-piperazinyl)ethane; 4-oleoyloxy-2,2,6,6-tetramethylpiperidine; and combinations thereof.

Other suitable UV stabilizers may include UV absorbers, such as benzotriazoles or benzopheones, which can absorb UV radiation. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2H-benzotriazol-2-yl)-4,6-bis(1-meth)-1-phenyl ethyl)phenol; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyl-oxypropyl)phenyl]benzotriazole; and combinations thereof. Exemplary benzophenone light stabilizers may likewise include 2-hydroxy-4-dodecyloxybenzophenone; 2,4-dihydroxybenzophenone; 2-(4-benzoyl-3-hydroxyphenoxy) ethyl acrylate (Cyasorb® UV 209 from Cytec); 2-hydroxy-4-n-octyloxy)benzophenone (Cyasorb® 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl) ester (Cyasorb® 712 from Cytec); 4,4′-dimethoxy-2,2′-dihydroxybenzophenone (Cyasorb® UV 12 from Cytec); and combinations thereof.

In addition to the UV stabilizer, the polyarylene sulfide composition can include other additives as are generally known in the art. In one embodiment, the polyarylene sulfide composition can include colorants as are generally known in the art. As previously stated, the reactive functionalization of the polyarylene sulfide can improve the dispersion and miscibility of a colorant throughout the composition, which can allow for a relatively high concentration of the colorant in the composition. For instance, the polyarylene sulfide composition can include from about 0.1 wt. % to about 10 wt. %, or from about 0.2 wt. % to about 5 wt.% of one or more colorants. As utilized herein, the term “colorant” generally refers to any substance that can impart color to a material. Thus, the term “colorant” encompasses both dyes, which exhibit solubility in an aqueous solution, and pigments, that exhibit little or no solubility in an aqueous solution.

Examples of dyes that may be used include, but are not limited to, disperse dyes. Suitable disperse dyes may include those described in “Disperse Dyes” in the Color Index, 3^{rd} edition. Such dyes include, for example, carboxylic acid group-free and/or sulfonic acid group-free nitro, amino, aminoketone, ketoninime, methine, polymethine, diphenylamine, quinoline, benzimidazole, xanthene, oxazine and coumarin dyes, anthraquinone and azo dyes, such as mono- or di-azo dyes. Disperse dyes also include primary red color disperse dyes that may include Disperse Red 60 (Intrasil Brilliant Red 2B 200%), Disperse Red 50 (Intrasil Scarlet 2 GH), Disperse Red 146 (Intrasil Red BSF), Disperse Red 127 (Dianix Red BSE), Dianix Red ACE, Disperse Red 65 (Intrasil Red MG), Disperse Red 86 (Terasil Pink 2 GLA), Disperse Red 191 (Intrasil Pink SRL), Disperse Red 338 (Intrasil Red 4BY), Disperse Red 302 (Tetrasil Pink 3G), Disperse Red 13 (Intrasperse Bordeaux BA), Disperse Red 167 (Foron Rubine S-2GFL), Disperse Violet 26 (Intrasil Violet FRL), etc.; primary blue color disperse dyes may include Disperse Blue 60 (Terasil Blue BGE 200%), Disperse Blue 291 (Intrasil Blue MGS), Disperse Blue 118 (Terasil Blue GBT), Terasil Blue HLB, Dianix Blue ACE, Disperse Blue 87 (Intrasil Blue FGB), Disperse Blue 148 (Palnnil Dark blue 3RT), Disperse Blue 56 (Intrasil Blue FBL), Disperse Blue 332 (Bafixan Turquoise 2 BL liq.), etc.; and primary yellow color dyes may include Disperse Yellow 64 (Disperite Yellow 3G 200%), Disperse Yellow 23 (Intrasil Yellow 5R), Palanil Yellow HM, Disperse Brown 19 (Dispersol Yellow D-7G), Disperse Orange 30 (Foron Yellow Brown S-2RFL), Disperse Orange 41 (Intrasil Orange 4RL), Disperse Orange 37 (Intrasil Dark Orange 3 GH), Disperse Yellow 3, Disperse Orange 30, Disperse Yellow 42, Disperse Orange 89, Disperse Yellow 235, Disperse Orange 3, Disperse Yellow 54, Disperse Yellow 233 (Foron Yellow S-6GL), etc.

Pigments that can be incorporated in a polyarylene sulfide composition can include, without limitation, organic pigments, inorganic pigments, metallic pigments, phosphorescent pigments, fluorescent pigments, photochromic pigments, thermochromic pigments, iridescent pigments, and pearlescent pigments. The specific amount of pigment can depends upon the desired final color of the product. Pastel colors are generally achieved with the addition of titanium dioxide white or a similar white pigment to a colored pigment.

Other additives can be incorporated in the polyarylene sulfide composition. In one embodiment, the polyarylene sulfide composition can include an organosilane coupling agent. The organosilane coupling agent may be an alkoxy silane coupling agent as is known in the art. The alkoxysilane compound may be a silane compound selected from the group consisting of vinlyalkoxysilanes, epoxyalkoxysilanes, aminoalkoxysilanes, mercaptoalkoxysilanes, and combinations thereof. Examples of the vinylalkoxysilane that may be utilized include vinyltriethoxysilane, vinyltrimethoxysilane and vinyltris(β-methoxyethoxy)silane. Examples of the epoxyalkoxysilanes that may be used include γ-glycidoxypropyltrimethoxysilane, β-(3,4-epoxycyclohexyl)ethyltrimethoxysilane and γ-glycidoxypropyltriethoxysilane. Examples of the mercaptoalkoxysilanes that may be employed include γ-mercaptopropyltrimethoxysilane and γ-mercaptopropyltriethoxysilane.

Amino silane compounds that may be included are typically of the formula: R³—Si—(R⁴)₃, wherein R³ is selected from the group consisting of an amino group such as NH₂; an aminoalkyl of from about 1 to about 10 carbon atoms, or from about 2 to about 5 carbon atoms, such as aminomethyl, aminoethyl, aminopropyl, aminobutyl, and so forth; an alkene of from about 2 to about 10 carbon atoms, or from about 2 to about 5 carbon atoms, such as ethylene, propylene, butylene, and so forth; and an alkyne of from about 2 to about 10 carbon atoms, or from about 2 to about 5 carbon atoms, such as ethyne, propyne, butyne and so forth; and wherein R⁴ is an alkoxy group of from about 1 to about 10 atoms, or from about 2 to about 5 carbon atoms, such as methoxy, ethoxy, propoxy, and so forth.

In one embodiment, R³ is selected from the group consisting of aminomethyl, aminoethyl, aminopropyl, ethylene, ethyne, propylene and propyne, and R⁴ is selected from the group consisting of methoxy groups, ethoxy groups, and propoxy groups. In another embodiment, R³ is selected from the group consisting of an alkene of from about 2 to about 10 carbon atoms such as ethylene, propylene, butylene, and so forth, and an alkyne of from about 2 to about 10 carbon atoms such as ethyne, propyne, butyne and so forth, and R⁴ is an alkoxy group of from about 1 to about 10 atoms, such as methoxy group, ethoxy group, propoxy group, and so forth. A combination of various aminosilanes may also be included in the mixture.

Some representative examples of amino silane coupling agents that may be included in the mixture include aminopropyl triethoxy silane, aminoethyl triethoxy silane, aminopropyl trimethoxy silane, aminoethyl trimethoxy silane, ethylene trimethoxy silane, ethylene triethoxy silane, ethyne trimethoxy silane, ethyne triethoxy silane, aminoethylaminopropyltrimethoxy silane, 3-aminopropyl triethoxy silane, 3-aminopropyl trimethoxy silane, 3-aminopropyl methyl dimethoxysilane or 3-aminopropyl methyl diethoxy silane, N-(2-aminoethyl)-3-aminopropyl trimethoxy silane, N-methyl-3-aminopropyl trimethoxy silane, N-phenyl-3-aminopropyl trimethoxy silane, bis(3-aminopropyl) tetramethoxy silane, bis(3-aminopropyl) tetraethoxy disiloxane, and combinations thereof. The amino silane may also be an aminoalkoxysilane, such as γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane and γ-diallylaminopropyltrimethoxysilane. One suitable amino silane is 3-aminopropyltriethoxysilane which is available from Degussa, Sigma Chemical Company, and Aldrich Chemical Company.

When included, the polyarylene sulfide composition may include the organosilane coupling agent in an amount from about 0.1 wt. % to about 5 wt.% by weight of the mixture, from about 0.3 wt. % to about 2 wt. % by weight of the mixture, or from about 0.2 wt. % to about 1 wt. % by weight of the mixture.

The composition can also include one or more fillers as are generally known in the art. One or more fillers may generally be included in the polyarylene sulfide composition an amount of from about 5 wt. % to about 70 wt. %, or from about 20 wt. % to about 65 wt. % by weight of the polyarylene sulfide composition.

The filler can be added to the polyarylene sulfide composition according to standard practice. For instance, the filler can be added to the composition at a downstream location of the melt processing unit. In addition, a filler can be added at a single feed location, or may be split and added at multiple feed locations along the melt processing unit.

In one embodiment, a fibrous filler can be included in the polyarylene sulfide composition. The fibrous filler may include one or more fiber types including, without limitation, polymer fibers, glass fibers, carbon fibers, metal fibers, and so forth, or a combination of fiber types. In one embodiment, the fibers may be chopped fibers, continuous fibers, or fiber ravings (tows).

Fiber sizes can vary as is known in the art. In one embodiment, the fibers can have an initial length of from about 3 mm to about 5 mm. Fiber diameters can vary depending upon the particular fiber used. The fibers, for instance, can have a diameter of less than about 100 μm, such as less than about 50 μm. For instance, the fibers can be chopped or continuous fibers and can have a fiber diameter of from about 5 μm to about 50 μm such as from about 5 μm to about 15 μm.

Particulate fillers, such as mineral fillers, may also be employed to help achieve the desired properties. When employed, such mineral fillers typically constitute from about 5 wt. % to about 60 wt. %, in some embodiments from about 10 wt % to about 50 wt.%, and in some embodiments, from about 15 wt. % to about 45 wt. % of the fibers. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂ (Si,Al)₄O₁₀[(OH)₂,(H₂O)]), montmorillonite (Na, Ca)_{0.33}(Al,Mg)₂Si₄O₁₀(OH)₂.nH₂O), vermiculite ((MgFe,Al)₃(Al,Si)₄O₁₀(OH)₂* 4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present invention. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂-3(AlSi₃)O₁₀(OH)₂), glauconite (K,Na)(Al,Mg,Fe)₂(Si,Al)₄O₁₀(OH)₂), etc., as well as combinations thereof.

Lubricants may also be employed that are capable of withstanding the processing conditions of polyarylene sulfide (typically from about 290° C. to about 320° C.) without substantial decomposition. Exemplary of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % of the fibers.

In one embodiment, the composition can include an impact modifier. Impact modifiers as may be included in the composition can include, without limitation, olefinic copolymers or terpolymers, crosslinked or non-crosslinked elastomers, graft copolymers made from an elastomeric, single-phase core and from a hard outer graft layer, etc. Examples of impact modifiers can include, e.g., polyurethanes, two-phase mixtures made from polybutadiene and styrene-acrylonitrile (ABS), modified polysiloxanes, silicone rubbers, and graft copolymers made from an elastomeric, single-phase core based on polydiene and from a hard outer graft layer (core-shell structure).

According to one embodiment, an impact modifier can be an olefinic copolymer or terpolymer modified to include functionalization so as to react with the reactively functionalized polyarylene sulfide. For instance, the impact modifier can be modified with a mole fraction of from about 0.01 to about 0.5 of one or more of the following: an α,β unsaturated dicarboxylic acid or salt thereof having from about 3 to about 8 carbon atoms; an α,β unsaturated carboxylic acid or salt thereof having from about 3 to about 8 carbon atoms; an anhydride or salt thereof having from about 3 to about 8 carbon atoms; a monoester or salt thereof having from about 3 to about 8 carbon atoms; a sulphonic acid or a salt thereof; an unsaturated epoxy compound having from about 4 to about 11 carbon atoms. Examples of such modification functionalities include maleic anhydride, fumaric acid, maleic acid, methacrylic acid, acrylic acid, and glycidyl methacrylate.

A non-limiting listing of impact modifiers that may be used include ethylene-acrylic acid copolymer, ethylene-maleic anhydride copolymers, ethylene-alkyl (meth)acrylate-maleic anhydride terpolymers, ethylene-alkyl (meth)acrylate-glycidyl (meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, an impact modifier can include a random terpolymer of ethylene, methylacrylate, and glycidyl methacrylate.

The molecular weight of an impact modifier can vary widely. For example, the impact modifier can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

When present, the impact modifier may be present in the composition in an amount from about 0.05% to about 25% by weight, such as in an amount from about 0.1% to about 15% by weight.

Still other additives that can be included in the mixture can encompass, without limitation, antimicrobials, antioxidants, other types of stabilizers, surfactants, waxes, flow promoters, solid solvents, and other materials added to enhance properties and processability. Such optional materials may be employed in conventional amounts.

The polyarylene sulfide composition may be melt processed according to techniques known in the art. For example, the starting polyarylene sulfide, the reactively functionalized disulfide compound, the UV stabilizer, and any other additives may be melt-kneaded in a single-screw or multi-screw extruder at a temperature of from about 250° C. to about 320° C. The composition may be melt processed in an extruder that includes multiple temperature zones. For instance, the composition may be melt processed in a multi-zone extruder that includes at least one temperature zone that is maintained at a temperature of between about 250° C. and about 320° C. A general purpose screw design can be used to melt process the composition. In one embodiment, the starting polyarylene sulfide, the reactively functionalized disulfide compound, and the UV stabilizer may all be fed to the feed throat in the first barrel of a multi-zone extruder by means of a metering feeder. In another embodiment, different components may be added at different addition points in the extruder, as is known. The mixture can be melted and mixed then extruded through a die. The extruded melt processed polyarylene sulfide composition can then be quenched in a water bath to solidify and granulated in a pelletizer followed by drying, e.g., drying at about 120° C.

The polyarylene sulfide composition can be utilized to form a desired product or component according to any desired processing technology or combination thereof. As previously stated, through utilization of the reactively functionalized polyarylene sulfide in the composition, phase separation between the polyarylene sulfide and the UV stabilizer can be avoided, which can provide a route to formation of products that define a small cross sectional dimension, such as fibers, tapes, films and relatively thin-walled molded components.

Polyarylene sulfide fibers may be in the form of individual staple fibers (fibers of a discrete length) or filaments (continuous fibers), or yarns containing multiple staple fibers or filaments. Yarns may include, for instance, multiple staple fibers that are twisted together (“spun yarn”), filaments laid together without twist (“zero-twist multi-filament yarn”), filaments laid together with a degree of twist (“twisted multi-filament yarn”), a single filament with or without twist (“monofilament”), etc. The staple fibers or filaments in the yarn can be formed from the same or different type of material. For example, a multi-filament yarn may contain polyarylene sulfide filaments in combination with fiber filaments formed of a different material.

The polyarylene sulfide fibers may be monocomponent fibers that are generally formed from the polyarylene sulfide composition or blend of the composition with an additional polymer but extruded from a single extruder. The additional polymer may include, for instance, polyolefins, aromatic polyesters, aliphatic polyesters, etc. In such fibers, the polyarylene sulfide composition typically constitutes from about 30 wt. % to about 95 wt. %, in some embodiments from about 35 wt. % to about 90 wt. %, and in some embodiments, from about 40 wt. % to about 80 wt. % of the fiber. Likewise, the polyarylene sulfide fibers may also be multicomponent fibers (e.g., bicomponent fibers) formed from the polyarylene sulfide composition and at least one additional polymer, which are extruded from separate extruders but spun together to form the fiber. Such multicomponent fibers may have a variety of configurations, such as sheath/core, side-by-side, island-in-the-sea, etc. In a sheath/core configuration, for example, a distinct zone of a first polymer component is surrounded by a distinct zone of a second polymer component. Typically, the second polymer component can be the polyarylene sulfide composition, which may constitute from about 30 wt.% to about 95 wt. %, in some embodiments from about 35 wt. % to about 90 wt. %, and in some embodiments, from about 40 wt. % to about 80 wt. % of the entire fiber.

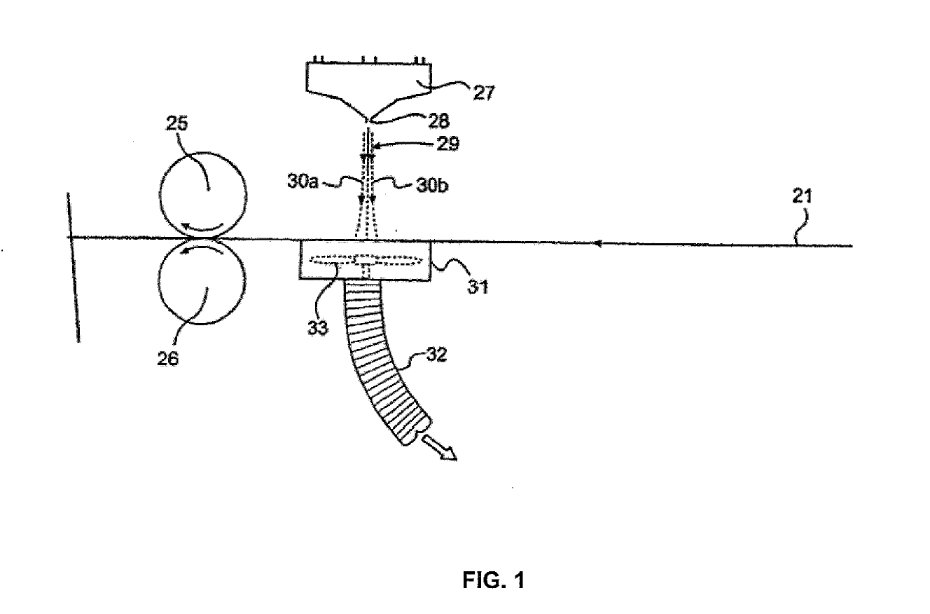

Fibers can be formed according to any formation process as is generally known including, without limitation, melt-blowing, spun-bonding, etc. By way of example, FIG. 1 illustrates one embodiment of a melt-blowing process as may be utilized for forming fibers including the polyarylene sulfide composition. The melt-blowing process includes extruding the polyarylene sulfide composition from an extruder 27 through a linear array of single-extrusion orifices 28 directly into a high velocity heated gaseous stream defined generally between 30a and 30b. The rapidly moving hot gas greatly attenuates the fibers 29 as they leave the orifices 28. The die tip is designed in such a way that the holes are in a straight line with high velocity gas impinging from each side 30a, 30b. A typical die will have holes spaced apart each having a diameter larger than that of the final fiber diameter. For example, in forming small diameter fibers, the die can have a plurality of aligned orifices 28 each have a diameter of between about 50 micrometers and about 200 micrometers, for instance between about 75 micrometers and about 150 micrometers. Formation process are not limited to small diameter fibers, however, and in other embodiment, the die can have larger orifices, for instance from about 200 micrometers to about 500 micrometers, or larger yet, as desired.

The impinging high-velocity hot gas attenuates the fibers and forms the desired fiber diameter. According to one embodiment, a low temperature and high pressure blow method can be utilized. For example, the extruder temperature can be between about 250° C. and about 380° C., or between about 270° C. and about 360° C. The high velocity gas can be at a temperature of between about 300° C. and about 410° C., between about 320° C. and about 390° C., or between about 330° C. and about 370° C. The gauge pressure of the blowing gas can be greater than about 1.5 kg/cm², for instance between about 2.0 kg/cm² and about 5.0 kg/cm². The temperature of the blowing gas is considered to be the temperature of the gas within the gas header (not shown on FIG. 1). In general, either air or steam is utilized as the blowing gas.

The melt blown fibers may be deposited on a conveyor or takeup screen 21. In one embodiment, the deposited fibers can have a small diameter, for instance less than about 50 micrometers, less than about 20 micrometers, or less than about 10 micrometers. According to one embodiment, during attenuation of the fibers, the fibers can also be broken in to discrete lengths to form small diameter staple fibers. For instance, the small diameter fibers can have a length of 30 millimeters or more, for instance from 100 mm to 500 mm. Alternatively, the fibers can be attenuated without formation of staple fibers, and small diameter filaments can be formed.

The fibers may be deposited on a conveyor or takeup screen 21 fed through rolls 25, 26 to form a random, entangled web. The fibers can be directed to the conveyor 21 by use of a suction device 31 that utilizes, e.g., a fan 33 that draws air away via tubing 32. Under the proper conditions, the fibers can still be somewhat soft at laydown and will tend to form fiber-fiber thermal bonds—that is, they will stick together. The combination of fiber entanglement and fiber-to-fiber cohesion can produce enough entanglement so that the web can be handled without further bonding.

According to another embodiment, the fibers may be deposited onto the conveyor or take-up screen 21 so as to avoid thermal bonding between the individual fibers. For example, the temperature of the high velocity gas stream and/or the distance from the extrusion orifices 28 to the conveyor 21 can be predetermined so as to avoid thermal bonding of the individual fibers. Following deposition, the fibers can be further processed, for instance by cutting or chopping so as to form staple fibers of shorter length, for instance less than about 100 millimeters, less than about 50 millimeters, or less than about 30 millimeters.

Staple fibers and filaments can be formed according to other known processes as well. For example, a spun-bonding process can be utilized in which a fiber is spun, optionally drawn, and deposited on the fiber forming fabric. Following formation of spunbond filaments, the filaments may be chopped to form staple fibers, though a spun-bonding process can also be utilized to directly form staple fibers, with no additional chopping or cutting operation necessary, as is known.

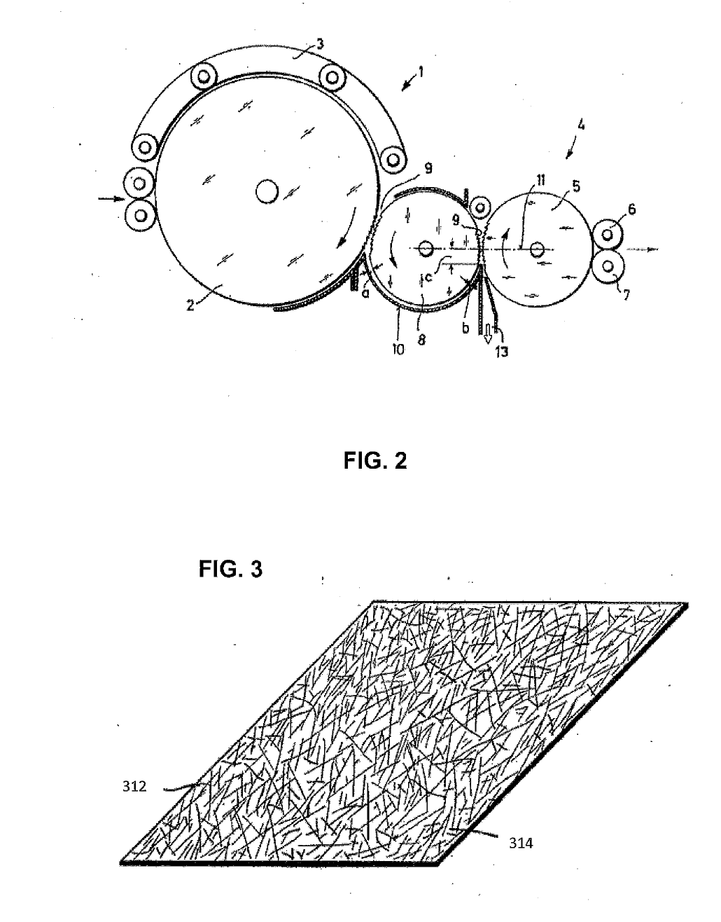

Staple fibers can be utilized to form a nonwoven web according to methods as are known in the art. For example, a nonwoven web can be formed according to carding technology, an example of which is illustrated in FIG. 2. A carding apparatus 1 can include a carding cylinder 2 which interacts in a conventional manner with covers 3 and/or a series of working rollers and clearer rollers (unnumbered) associated therewith. The apparatus 1 has been illustrated in FIG. 2 having a single carding cylinder 2 and associated covers 3 and the series of working rollers (unnumbered) associated therewith, but it is to be understood that several such cylinders 2 and covers 3 with associated working rollers might be utilized as is known. Moreover, as is conventional, there is provided stripper device 4 that includes a stripper roller 5 and a pair of take-off rollers 6 and 7. The stripper device 4 may also have associated therewith a doffer comb (not shown) or the like.

Between the stripper device 4 and the carding cylinder 2 is an intermediate toothed roller 8 having sets of teeth 9 along a surface thereof adjacent to which there is disposed a material guide plate 10 which converges in the direction of rotation of the roller 8, as is indicated by the unnumbered headed arrow associated therewith. Thus, the material fed between and by the intermediate roller 8 and the guide plate 10 initially enters between the two at an initial clearance “a” which is greater than a final clearance “b” downstream from the initial clearance “a” prior to the material exiting beyond the guide plate 10. The clearance from the teeth 9 of the intermediate roller 8 and the guide plate 10 can be, for example, from about 4 to about 6 mm at the clearance “a” and about 1 mm at the clearance “b.” The material guide plate 10 terminates a predetermined distance “c” from the point at which the stripper roller 5 becomes operative, i.e., ahead of the imaginary line 11 connecting the centers of the intermediate roller 8 and the stripper roller 5. The section or area “c” between the surfaces of the toothed opposing rollers 5, 8 represents a free non-woven fabric-forming zone in which the jamming effect in the diminishing clearance from “a” to “b” is abruptly discontinued or released whereby some of the fibers carried by the intermediate toothed roll 8 become detached from the teeth 9 thereof with subsequent formation of a non-woven fabric of matted fibers on the stripper roll 5. The free zone “c” for formation of the non-woven fabric may have a length of from about 8 to about 12 millimeters. The free length of the zone “c” can be, for example, about 10 millimeters.

The rotational speed of the carding cylinder 2 to the intermediate toothed roller 8 can be coordinated so that the surface speed becomes greater from cylinder to roller. The transfer factor may be, for example, about 1.5. The rotational speed of the intermediate toothed roller 8 to the stripper roller 5 is so coordinated that the surface speed from roller 8 to roller 5 is considerably reduced. The speed ratio from the roller 8 to the roller 5 can generally be from about 10:1 to about 100:1.

The apparatus 1 can also include a suction device 13 operative at the free zone “c” for the formation of the non-woven web, and by means of such suction, the air from the gap or zone between the rollers 8 and 5 is drawn or carried away. Depending upon the degree of bunching and after-treatment of the webs produced, a carding process can be utilized for producing relatively light-weight nonwoven webs, for instance in a weight range of between about 8 and about 25 grams per square meter of fabric surface area. Carded web formation techniques are not limited to formation of lightweight nonwoven webs, however, and can be utilized to form medium weight webs (e.g., from about 25 to about 70 grams per square meter), or heavy weight webs (e.g., greater than about 70 grams per square meter).

Fibrous webs formed of the polyarylene sulfide composition can be utilized in a variety of applications including, without limitation, as battery separators, oil absorbers, filter media, hospital-medical products, insulation batting, and the like. By way of example, FIG. 3 illustrates a fibrous nonwoven web 312 comprising a plurality of polyarylene sulfide fibers 314. A fibrous nonwoven web 312 may be used in one embodiment to capture fine particles from a gas or liquid stream. For instance, a filter including fibers formed of the polyarylene sulfide composition can be utilized in filtering fuel, oil, exhaust, other fluids in an engine, e.g., an automotive engine, or in forming a filter bag, for instance as may be utilized with an industrial smokestack. Nonwoven webs including the polyarylene sulfide composition can also be utilized in forming insulation materials, such as insulative paper or fabrics in electrical components.

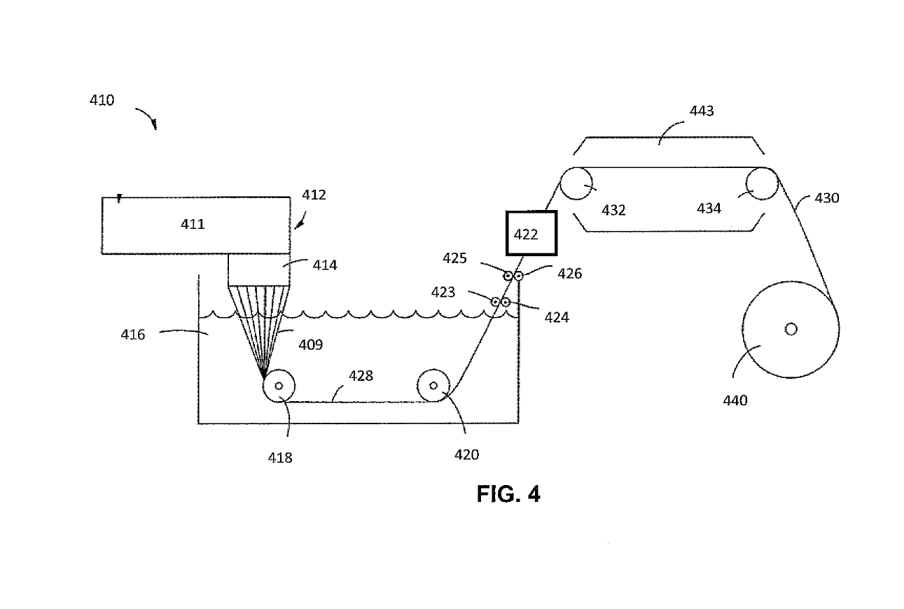

Polyarylene sulfide fibers can be formed according to other extrusion processes as are known. For example, FIG. 4 illustrates a process and system 410 by which a drawn yarn may be formed of the polyarylene sulfide composition. According to the illustrated embodiment, the polyarylene sulfide composition, for instance in the form of pellets or chips, can be provided to an extruder apparatus 412.

According to another embodiment, the polyarylene sulfide composition can be formed in the extruder apparatus 412. For instance, the starting polyarylene sulfide polymer, the reactively functionalized disulfide compound, and the UV stabilizer can be fed to the extruder apparatus 412, and the composition can be formed in the extruder apparatus 412.

The extruder apparatus 412 can include a mixing manifold 411 in which the polyarylene composition can be heated to form a molten composition and optionally mixed with any additional additives. If desired, to help ensure the fluid state of the molten mixture, the molten mixture can be filtered prior to extrusion. For example, the molten mixture can be filtered to remove any fine particles from the mixture by use of a filter with about 325 mesh or finer.

Following formation of the molten mixture, the mixture can be conveyed under pressure to the spinneret 414 of the extruder apparatus 412, where it can be extruded through one or more spinneret orifices to form one or more filaments 409. Extrusion temperatures in the range of about 280° C. to about 340° C. can be employed, for instance in the range of about 290° C. to about 320° C. Following extrusion of the polyarylene sulfide composition to form the filament 409, the undrawn filaments 409 can be quenched in a liquid bath 416 and collected by a take-up roll 418, for instance to form a multifilament fiber structure or fiber bundle 428. Take-up roll 418 and roll 420 can be within bath 416 and convey individual filaments 409 and the gathered fiber bundle 428 through the bath 416. Dwell time of the material in the bath 416 can vary, depending upon line speed, bath temperature, fiber size, etc. Following exit from the quenching bath, the fiber bundle 428 can pass through a series of nip rolls 423, 424, 425, 426 to remove excess liquid from the fiber bundle 428. Optionally, a lubricant can be applied to the fiber bundle 428. For example, a spin finish can be applied at a spin finish applicator chest 422. Following, the polyarylene sulfide fiber bundle can be drawn at temperatures in the range of 90° C. to 110° C. using conventional equipment having a draw zone designed to heat the fiber to the appropriate temperature. For example, in the embodiment illustrated in FIG. 4, the fiber bundle 428 can be drawn in an oven 443. Additionally, in this embodiment, the draw rolls 432, 434 can be either interior or exterior to the oven 443, as is generally known in the art. Subsequent to drawing the fiber bundle 428 a hot roll 440 or heated zone in a temperature range of 100° C. to about 200° C. can be used to at least partially crystallize the formed polyarylene sulfide fiber 430.

Following formation, the drawn fiber bundle can be utilized as formed, for instance in forming a woven web, a prepreg composite, or the like, or may be chopped to a desired length to form staple fibers as may be utilized in woven or nonwoven webs. A woven web can include polyarylene sulfide fibers in the warp, weft, or both directions. Moreover, the warp and/or weft can include other fibers, in addition to or alternative to the polyarylene sulfide fibers.

A woven web can be formed via warp knit or weft knit, as desired. Any type of knitting machine can be utilized including, without limitation, a weft knitting machine, in which a web is knitted in a continuous, uninterrupted length of constant width; a garments length machine that has an additional control mechanism to co-ordinate the knitting action in the production of structured repeat sequence in a wale direction; a flat machine; a circular machine; and so forth.

Linear warp-knitting machines as may be utilized include a plurality of bars designed to carry a plurality of thread-holding elements, commonly known as thread-guides. The bars can be moved so as to enable the threads associated with such thread-guides to be correctly fed onto the needles of the knitting machine for the formation of new fabric. In order to achieve its knitting task, the thread-guide bar makes two basic movements: a linear movement in front of or behind the hook of each needle, commonly known as “shog”, and an oscillating movement on the side of each needle for bringing the threads alternatively before and behind the needle hook, commonly known as “swing”. Jacquard-type thread-guide bars are also known, which are provided with jacquard devices allowing each thread-guide to move individually of an additional needle space, in the same or opposite direction, with respect to the shog movement of the bars.

In a weft knitting machine the loops are produced in a horizontal direction. A weft knitting machine is generally provided with a yarn feeder mounted, e.g., on a side cover on one end side in a longitudinal direction of a needle bed, so the knitting yarn is fed from a yarn feeding port of a yarn feeding member to a knitting needle. The yarn feeder includes a buffer rod that can temporarily store a knitting yarn and can apply a tension to the knitting yarn.

Webs as may be formed from the polyarylene sulfide composition can include high performance woven or nonwoven webs such as agrotextiles, construction textiles, geotextiles, automobile textiles, high temperature protective textiles, etc. as well as more traditional webs such as apparel textiles, medical textiles, sports textiles, upholstery textiles, and the like. Beneficially, the UV stabilization of the polyarylene sulfide can provide woven and nonwoven webs with long life and improved appearance over the life of the product.

Products that may be formed of the polyarylene sulfide composition are not limited to fibers and fibrous materials. Other formation processing as is generally known may be utilized in conjunction with the polyarylene sulfide composition. For instance, in one embodiment the polyarylene sulfide composition can be extruded or otherwise molded to form tapes, films, or other products that can have a small cross sectional dimension. For example, a tape or film formed of the polyarylene sulfide composition can have a cross sectional dimension of less than about 50 micrometers, less than about 30 micrometers, or less than about 10 micrometers. Extruded tapes and films can be beneficially utilized, for example, in forming high performance laminates.

Other conventional shaping processes for forming articles that include the polyarylene sulfide composition include, without limitation, injection molding, blow-molding, thermoforming, foaming, compression molding, hot-stamping, etc. In one embodiment, molded products can have a small cross sectional dimension, for instance a cross sectional dimension of less than about 10 millimeters.

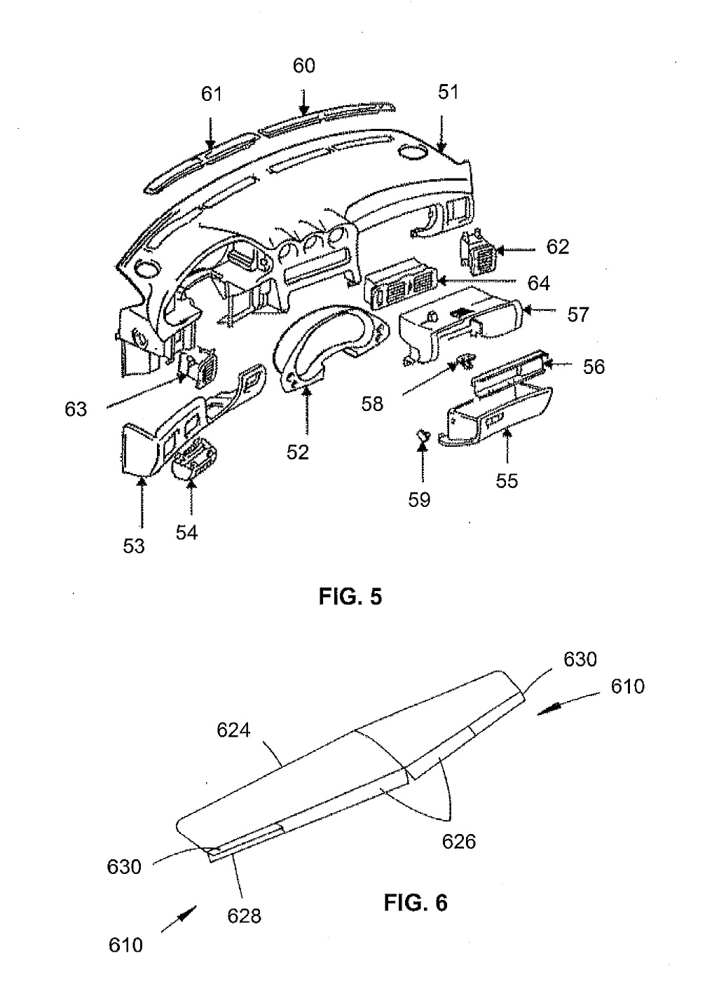

Molded products, e.g., injection molded or blow molded products, that can incorporate the polyarylene sulfide composition can include, but are not limited to, products that are expected to encounter high levels of UV radiation over the lifetime of the product. The improved resistance to UV degradation of the polyarylene sulfide composition can be particularly beneficial in increase the life of such products. By way of example, the polyarylene sulfide composition may be beneficially utilized in forming components such as dashboards, electrical parts such as switches or electronic panels, chemically-resistant and weather-resistant parts and apparatus, such as pipes, hoses, pump housings and pump impellers, and the like. For example, FIG. 5 illustrates a plurality of vehicle dashboard components, one or more of which may be formed from the polyarylene sulfide composition according to an injection molding or blow molding process. Exemplary components of a vehicle dashboard can include the dash pad 51, the cluster bezel 52, the lower cover 53, the vent cover 54, the glove box 55, the cover inner 56, the cover upper 57, the striker 58, the stopper 59, the defrost grills 60, 61, the outer vents 62, 63, and the center grill vent 64.

Components for other types of vehicles can also be beneficially formed from the polyarylene sulfide composition. For example, FIG. 6 illustrates a general aviation type wing 624 with full-span flaps including the main flap 626 and the auxiliary flap 628 deployed together. Both the main flap 626 and the auxiliary flap 628 are shown in FIG. 6 at maximum deflection. In this mode the aileron panels 630 can remain stowed in the neutral position or each can be deflected up individually for roll control. The ailerons 610 can be completely or partially formed of the polyarylene sulfide composition. For example, the leading edges of the aileron panels 630, mail flaps 626 and auxiliary flaps 28 can be formed of the polyarylene sulfide composition.

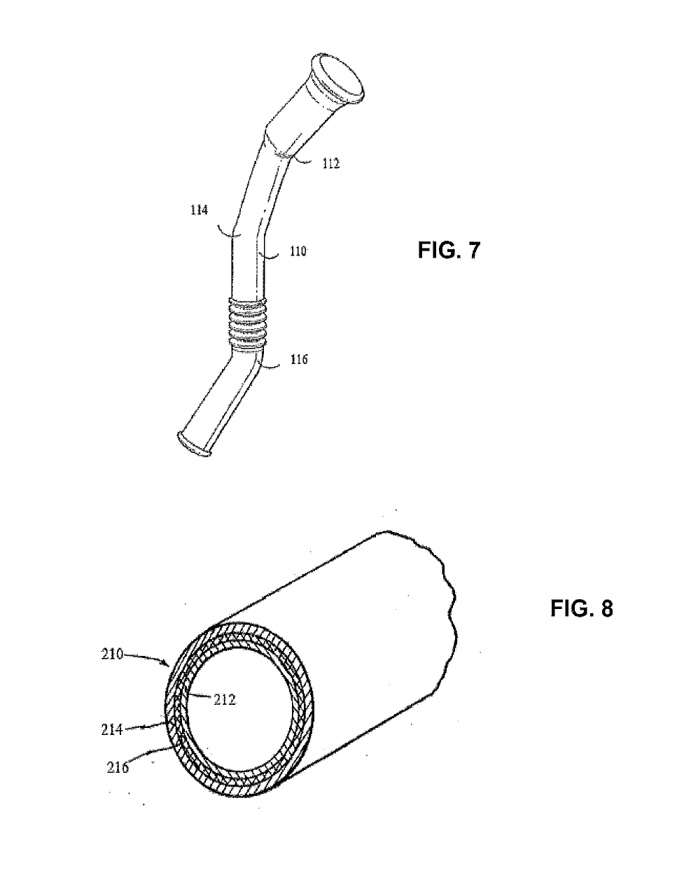

Referring to FIG. 7, one embodiment of a tubular member 110 formed from the polyarylene sulfide composition is shown. As shown, the tubular member 110 extends in multiple directions leading to a relatively complex shape. For instance, before the polyarylene sulfide composition can solidify, the angular displacements as shown in FIG. 7 can be formed into the part. The tubular member 110 includes angular displacement changes at 112, 114 and 116. The tubular member 110 may comprise, for instance, a part that may be used in carrying a fluid, for instance a heated liquid or gas.

According to one embodiment, the tubular member 110 can be a single layer tubular member formed according to a blow molding process. During blow molding, the polyarylene sulfide composition is first heated and extruded into a parison using a die attached to an extrusion device. When the parison is formed, the composition must have sufficient melt strength to prevent gravity from undesirably elongating portions of the parison and thereby forming non-uniform wall thicknesses and other imperfections. The parison is received into a molding device, generally formed of multiple sections that together form a three-dimensional mold cavity.

As can be appreciated, a certain period of time elapses from formation of the parison to moving the parison into engagement with the molding device. During this stage of the process, the melt strength of the polyarylene sulfide composition can be high enough such that the parison maintains its shape during movement. The polyarylene sulfide composition can also be capable of remaining in a semi-fluid state and not solidifying too rapidly before blow molding commences.

Once the molding device is closed, a gas, such as an inert gas is fed into the parison from a gas supply. The gas supplies sufficient pressure against the interior surface of the parison such that the parison conforms to the shape of the mold cavity. After blow molding, the finished shaped article is then removed. In one embodiment, cool air can be injected into the molded part for solidifying the polyarylene sulfide composition prior to removal from the molding device.

A tubular member that incorporates the polyarylene sulfide composition can be a multi-layered tubular member. FIG. 8 illustrates a multi-layered tubular member 210 as may incorporate the polyarylene sulfide composition in one or more layers of the tubular member. For example, at least the outer layer 214 can include the polyarylene sulfide composition that exhibits high resistance to degradation due to UV radiation.

The inner layer 212 and the intermediate layer 216 can include a polyarylene sulfide composition that is the same or different than the polyarylene sulfide composition described herein. Alternatively, other layers of the multilayer tubular member may be formed of different materials. For example, in one embodiment the intermediate layer 216 can exhibit high resistance to pressure and mechanical effects. By way of example, layer 216 can be formed of polyamides from the group of homopolyamides, co-polyamides, their blends or mixtures which each other or with other polymers. Alternatively, layer 216 can be formed of a fiber reinforced material such as a fiber-reinforced resin composite or the like. For example, a polyaramid (e.g., Kevlar®) woven mat can be utilized to form an intermediate layer 216 that is highly resistant to mechanical assaults.

Examples of non-polyarylene sulfide materials as may be utilized in forming the inner layer can include, for example, polyolefin thermoplastic elastomer and styrene thermoplastic elastomer.

Of course, a multi-layer tubular member is not limited to three layers, and may include two, four, or more distinct layers. A multi-layer tubular member may further contain one or more adhesive layers formed from adhesive materials such as, for example, polyester polyurethanes, polyether polyurethanes, polyester elastomers, polyether elastomers, polyamides, polyether polyamides, polyether polyimides, functionalized polyolefins, and the like.

Multilayer tubular members may be made by conventional processes, such as, for example, co-extrusion, dry lamination, sandwich lamination, coextrusion coating, and the like. By way of example, in forming a three-layered tubular member 210 as illustrated in FIG. 8, the polyarylene sulfide composition, a polyamide composition, and a polyolefin thermoplastic composition can be separately fed into three different extruders. The separate extrusion melts from those three extruders can then be introduced into one die under pressure. While producing three different tubular melt flows, those melt flows can be combined in the die in such a manner that the melt flow of the polyarylene sulfide composition forms the outer layer 214, that of the polyamide composition forms the intermediate layer 216, and that of the polyolefin thermoplastic composition forms the inner layer 212, and the thus-combined melt flows are co-extruded out of the die to produce a three-layered tubular member.

Of course, any known tube-forming methods including blow molding methods is employable. For instance, in one embodiment, one or more layers of the multi-layered tubular member can be formed from a continuous tape, e.g., a fiber reinforced tape or ribbon formed according to a pultrusion formation method. A tape can be wrapped to form the tubular member or a layer of a multilayered tubular member according to known practices as are generally known in the art.

Formed products can be further processed as desired. For instance, formed products can be coated with a colorant according to any suitable process. As previously discussed, the reactive functionality of the polyarylene sulfide composition is believed to provide a surface that can better adhere to a coating applied to the surface. A coating solution may be applied using any conventional technique, such as bar, roll, knife, curtain, print (e.g., rotogravure), spray, slot-die, drop-coating, or dip-coating techniques. In one embodiment, for example, yarn can be treated with a saturating liquor (called a “pad bath”) with a nip roll squeeze after each bath saturation. Yarn can also be treated in “package” form with the saturating liquor. Woven fabrics can be pad bath finished in continuous stenter (open width) frames or with batch processes such as, piece dyeing, jet, beck, jigger or paddle machines. Knit fabrics can be processed in the same machinery (both continuous and batch) as woven fabrics, just under different conditions. For garments, industrial garment washing machines may be used. Optional application methods include manual processes such as spraying or manual wet add-on techniques. Molded products such as injection or blow molded components can be coated, for example, according to a dip-coating, spray coating, or other suitable application process.

Embodiments of the present disclosure are illustrated by the following examples that are merely for the purpose of illustration of embodiments and are not to be regarded as limiting the scope of the invention or the manner in which it may be practiced. Unless specifically indicated otherwise, parts and percentages are given by weight.

### Test Methods

Melt Viscosity: The melt viscosity is reported as scanning shear rate viscosity. Scanning shear rate viscosity as reported herein was determined in accordance with ISO Test No. 11443 (technically equivalent to ASTM D3835) at a shear rate of 1200 s⁻¹ and at a temperature of 310° C. using a Dynisco 7001 capillary rheometer. The rheometer orifice (die) had a diameter of 1 mm, a length of 20 mm, an L/D ratio of 20.1, and an entrance angle of 180°. The diameter of the barrel was 9.55 mm±0.005 mm and the length of the rod was 233.4 mm.

Fiber Characteristics: Fiber characteristics including denier, breaking tenacity, and breaking elongation were determined in accordance with ASTM D5446-08.

UV Degradation: Effect of UV exposure on color was determined according to Ford FLTM BO 116-01 Testing Method utilizing a xenon arc wetherometer. Total exposure was 50 kJ/m² (approximately 16 hours exposure at 1.06 W/m² at 420 nm). Testing conditions for the light cycle included 89° C. black panel temperature, 50% relative humidity, and a cycle time of 3.8 hours. Testing conditions for the dark cycle included 38° C. black panel temperature, 95% relative humidity, and a cycle time of 1.0 hour.

### Example 1

Materials utilized were as follows:

### Starting Polyarylene Sulfide

PPS1—Fortron® 0309B4—A low melt viscosity, unfilled polyphenylene sulfide polymer available from Ticona Engineering Polymers of Florence, Ky.

PPS2—Fortron® 0320B0—A high melt viscosity, unfilled polyphenylene sulfide polymer available from Ticona Engineering Polymers of Florence, Ky.

UV—UV 234—An ultraviolet absorbent (2-(2H-benzotriazol-2-yl)-4,6-bis(1-methyl-1-phenyl ethyl)phenol) available from W.F. McDonald Company, Los Angeles, Calif.

Disulfide—Dithiodibenzoic Acid

Samples were formed in an extrusion process as follows:

Following formation, samples were tested to determine melt viscosity. Sample formulations and melt viscosity results are shown in Table 1, below. Sample formulations provide the components as weight percentages.

TABLE 1

| | | | | | Melt |
|---|---|---|---|---|---|
| | | | | | Viscosity |
| Sample No. | PPS1 | PPS2 | UV | Disulfide | (poise) |
| 1 | | 97.5 | 2 | 0.5 | 792 |
| 2 | 98 | | 2 | | 1068 |
| 3 | 100 | | | | 1142 |
| 4 | | 98 | 2 | | 2352 |
| 5 | | 97.7 | 2 | 0.3 | 1049 |
| 6 | | 98 | 2 | | 2275 |
| 7 | | 97.7 | 2 | 0.3 | 979 |
| 8 | | 100 | | | 2851 |
| 9 | | 99.5 | | 0.3 | 1337 |

As can be seen, addition of the disulfide compound provides a large decrease in the melt viscosity of the starting polyarylene sulfide.

Sample No. #2 and Sample No. #3 (as control) were tested for UV degradation characteristics. Results are provided in Table 2, below:

TABLE 2

Sample No.

| | 2 | 3 |
|---|---|---|
| ΔL* | −10.82 | −17.79 |
| Δa* | +4.08 | +6.58 |
| Δb* | +13.51 | +16.57 |
| ΔE | 17.78 | 25.19 |

As can be seen, the addition of a UV stabilizer to the composition improves the color retention of the composition.

Fibers were formed from some of the samples. Fiber formation processing parameters are provided in Table 3, below:

TABLE 3

| | Sample No. | | |
|---|---|---|---|
| | 3 | 2 | 7 |
| Spinneret Die | 132#/9 milφ | 132#/9 milφ | 132#/9 milφ |
| Melt Temp. (° C.) | 330 | 316 | 311 |
| Die Pressure (psi) | 643 | 837 | 646 |
| Winding speed | 1000 | 800 | 1000 |
| (mpm) | | | |
| Spun denier (dpf) | 4.84 | 5.64 | 4.85 |
| Processability | Normal | Difficult | Normal |
| Broken filaments | No | Yes | No |

The fibers were drawn following formation and tested for denier, breaking tenacity and breaking elongation. Drawing parameters and product characteristics are provided in Table 4, below:

TABLE 4

Sample No.

| | 3 | 7 |
|---|---|---|
| Drawing Temp. (° C.) | 95 | 95 |
| Draw Ratio | 3.27 | 3.27 |
| Denier (dpf) | 1.54 | 1.52 |
| Breaking Tenacity | A | 96.7% of A |
| (gpd) | | |
| Breaking Elongation | B | 116.7% of B |
| (%) | | |

While certain representative embodiments and details have been shown for the purpose of illustrating the subject invention, it will be apparent to those skilled in this art that various changes and modifications may be made therein without departing from the scope of the subject invention.

What is claimed is:

1. A polyarylene sulfide composition comprising a reactively functionalized polyarylene sulfide and a UV stabilizer, wherein the polyarylene sulfide composition has a color shift ΔE following a period of UV aging that is less than about 90% of that of a second polyarylene sulfide composition, the second polyarylene sulfide composition comprising a second polyarylene sulfide polymer, the second polyarylene sulfide composition varying from the polyarylene sulfide composition only in that the second polyarylene sulfide polymer of the second composition is not a reactively functionalized polyarylene sulfide.

2. The polyarylene sulfide composition according to claim 1, wherein the polyarylene sulfide composition has a chlorine content of less than about 1500 ppm.

3. The polyarylene sulfide composition according to claim 1, wherein the polyarylene sulfide composition further comprises one or more of a colorant, an organosilane coupling agent, a filler, or an impact modifier.

4. The polyarylene sulfide composition according to claim 1, wherein the reactively functionalized polyarylene sulfide is a polyphenylene sulfide.

5. A fiber, tape, or film comprising the polyarylene sulfide composition according to claim 1.

6. An injection molded, blow molded, thermoformed, foamed, compression molded, or hot-stamped product comprising the polyarylene sulfide composition according to claim 1.

7. A molded product comprising a polyarylene sulfide composition, the polyarylene sulfide composition comprising a reactively functionalized polyarylene sulfide and a UV stabilizer, wherein the molded product defines a cross section of less than about 10 millimeters.

8. The molded product according to claim 7, wherein the UV stabilizer comprises greater than about 0.5% by weight of the polyarylene sulfide composition.

9. The molded product according to claim 7, wherein the molded product has a chlorine content of less than about 1500 ppm.

10. The molded product according to claim 7, wherein the molded product is a staple fiber or a filament.

11. The molded product according to claim 10, wherein the staple fiber or filament has a linear mass density of less than about 5 grams per 10,000 meters and/or a diameter of less than about 50 micrometers.

12. A nonwoven or woven web comprising the staple fiber or filament of claim 10.

13. The molded product according to claim 7, wherein the molded product is a tape or film having a cross sectional dimension of less than about 50 micrometers.

14. A laminate comprising the tape or film of claim 13.

15. The molded product according to claim 7, wherein the molded product is an automotive component.

16. The molded product according to claim 7, wherein the molded product is a tubular member.

17. A method for forming a polyarylene sulfide composition comprising melt processing a starting polyarylene sulfide, a reactively functionalized disulfide compound, and a UV stabilizer, the starting polyarylene sulfide and the reactively functionalized disulfide compound reacting with one another to form a reactively functionalized polyarylene sulfide.

18. The method according to claim 17, wherein the disulfide compound has the following structure:
R¹—S—S—R²
wherein R¹ and R² are the same or different and at least one of R¹ and R² includes a terminal carboxyl group, hydroxyl group, a substituted or non-substituted amino group, or a nitro group.

19. The method according to claim 17, wherein the ratio of the amount of the starting polyarylene sulfide to the amount of the reactively functionalized disulfide compound is from about 1000:1 to about 10:1.

20. The method according to claim 17, further comprising incorporating an organosilane coupling agent and/or a filler into the polyarylene sulfide composition.

21. The method according to claim 17, further comprising carding a plurality of fibers, the fibers comprising the polyarylene sulfide composition.

22. The method according to claim 17, further comprising forming a filament or staple fiber comprising the polyarylene sulfide composition.

23. The method according to claim 17, further comprising injection molding, blow molding, thermoforming, foaming, compression molding, or hot-stamping the polyarylene sulfide composition.

24. The method according to claim 17, wherein the starting polyarylene sulfide has a viscosity of greater than about 2500 poise.
